(19) United States
(12) Patent Application Publication
(10) Pub. No.: US 2005/0267813 A1
(43) Pub. Date: Dec. 1, 2005

(54) Method and system for marketing items displayed in entertainment programs such as music videos, television programs, and the like

(76) Inventor: Edward M. Monday, Independence, MO (US)

Correspondence Address: Bryan P. Stanley;Sonnenschein Nath & Rosenthal, Wacker Drive Station, Sears Tower, P.O. Box #061080, Chicago, IL, 60606-1080, US

(21) Appl. No.: 10/853,839

(22) Filed: May 26, 2004

(51) Int. Cl. G06F 17/60; H04N 5/445

(52) U.S. Cl. 705/26; 705/14; 725/42

(57) ABSTRACT

A system and method of marketing an item is provided. Items are displayed during an entertainment program. Information corresponding to the source(s) for purchase of the displayed item(s) is presented to the viewer of the entertainment program by a video or audio overlay. In one embodiment of the inventive system, contact information for the source of purchasing the items is presented in the overlay. In another embodiment a pointer, such as a web address is presented via the overlay. The web address provides the viewer with the location of a website in which information can be obtained to purchase item(s) displayed during the entertainment program. The website can include a database list of items that are displayed in the entertainment program, which can be searched by program title, entertainer name and other similar criteria.

### FIELD OF THE INVENTION

The present invention relates generally to a method and system for marketing items during an entertainment program, such as a music video, television program, sitcom, drama, awards show, televised sporting event or other similar program. More specifically, the present invention is concerned with a method and system for marketing items used by the entertainers or displayed as part of the entertainment program. The present invention is particularly well suited for marketing items for which the source of the items is not easily obtainable, such as unique clothing items worn by Hip Hop artists in music videos.

### BACKGROUND OF THE INVENTION

Music videos have become an increasingly popular entertainment source over the last few decades, such that several television networks now exist that primarily televise music videos. Examples of such music video networks include MTV, MTV2, MTV JAMS, VH1, VH1 CLASSIC, VH1 SOUL, BET and CMT to name a few. As with any popular entertainment program, marketing of products targeted towards the viewing audiences of music videos is a huge business. Items are marketed to the viewing audience of a music video network through commercials that are aired between videos. Because of the limited air-time available for commercial space during popular entertainment programs, this space is often extremely expensive. Therefore, televised commercials are generally only feasible for marketing items that appeal to a relatively high percentage of the public in general, and which are usually mass-produced and readily available for purchase at a variety of marketplaces that are convenient to the majority of the general public. Examples of such “commodity” type items that are generally marketed through televised commercials include name brand soft-drinks (i.e. Coke, Pepsi, etc.), apparel (i.e. Nike, Adidas, Reebok), electronics (TV's, stereos, CD players), etc., all of which are sold at retail locations throughout the United States and abroad.

Unique or specialty items, that are not mass produced, and which are usually only sold in limited quantities at specified locations through dispersed markets, such as boutique shops, are not usually conducive to the use of mass market commercials. Therefore, marketing and promotion of such items is usually extremely limited. In many instances, the only way people discover where to purchase certain specialty items is through word of mouth. While this difficulty in locating certain items adds to the uniqueness of those items, there are many items that are offered by small boutique shops or independent retailers that could be produced and/or sold in higher quantities if a larger population of purchasers had knowledge of where to purchase those items.

Hip Hop clothing provides an example of items that have a relatively high demand, but which are often sold in dispersed markets through small boutique shops or independent retailers that currently use little, if any, advertisements for their products. The sales of Hip Hop clothing items are estimated to total nearly $2 billion each year. Hip Hop is a form of music that has been increasing in popularity for several decades, and which is extremely popular in music videos. Hip Hop has evolved beyond a mere form of entertainment. It has become its own community, a way of life. Fans of Hip Hop strongly associate with the Hip Hop artists and the freedom of form and rebellion messages that are conveyed through their music. The Hip Hop artists are usually trend setters in the Hip Hop community. Fans desire to dress in the same fashion as their favorite artists dress, and many artists even have their own clothing lines.

Most Hip Hop fans discover new fashion ideas through watching music videos. The clothing items worn by Hip Hop artists in music videos are usually the highest quality and the latest trends. Thus, many fans want to purchase the exact same clothing designs that they see in the music videos. Nevertheless, locating the exact clothing designs seen in a music video is often difficult even though many lines of Hip Hop clothing are available nationwide, such as Sean John, Phat Farm, Rocawear, and G-Unit to name a few.

This difficulty arises for several reasons. First, the source of a specific clothing item worn by a Hip Hop artist during a music video is often not identifiable during the music video, and as the music video is produced for entertainment purposes rather than advertising purposes there is not effort to make items identifiable. Even if the name of the product line is visible, it may be too small to read on the viewer's television screen. Second, even when the brand name of a clothing item is identifiable in a video, that specific item may not be available in every store that sells that brand. This is particularly true for clothing lines, which may include hundreds or thousands of different designs. It is difficult, if not impossible, for a single store to carry all designs available for a clothing line. Third, the artist's outfit may be put together from several different brands of clothing, and may even include vintage (i.e. clothing no longer manufactured) or specialty items (i.e. professional athletic jerseys).

Thus, a single outfit worn by a Hip Hop artist in a music video may include items acquired from a variety of different sources. The artist's shirt may be sold by a small shop in one city, the pants in another store in a different city, the hat in yet another store, and so forth. Thus, obtaining the same outfit worn by a Hip Hop artist in a specific music video is often difficult, if not impossible to accomplish. Therefore it would be advantageous to provide a system and method of marketing items that are available in highly dispersed markets, such as the dispersed markets for purchasing Hip Hop clothing.

### SUMMARY OF THE INVENTION

An object of the present invention is to provide a system and method of marketing items that are displayed during an entertainment program, such as a music video, a television program, or other similar program. Another object of the present invention is to provide a system and method of marketing items that are displayed during an entertainment program without disrupting the entertainment program. Another object of the present invention is to provide a system and method of marketing items sold through dispersed markets.

The above described objects are achieved by a system that displays an item during an entertainment program and which provides information regarding a source for purchasing the displayed item to a purchaser. In one embodiment of the instant invention, information regarding a source for purchasing a displayed item is obtained, and a program overlay is generated corresponding to the source information. The program overlay is presented during the entertainment program generally concurrent with the display of the item, and the viewer can then utilize the information from the program overlay to purchase the displayed item. In another embodiment of the instant invention, information regarding a source for purchasing a displayed item is obtained and stored in a list in association with the entertainment program in which the items are displayed. The list of items associated with the entertainment program can be presented via a display overlay as discussed above, or alternatively, the list can be presented independent or separate from the entertainment program display, such as on a separate television channel or via a website. The viewer of the entertainment program can access the list and use the source information to purchase the desired displayed item.

In a preferred embodiment, the system and method of the instant invention is used to market clothing items worn by a Hip Hop artist and other performers in a music video. In most instances, the potential purchaser will be viewing the music video for entertainment purposes. As the viewer is watching the video, the viewer will see a number of items worn by singers, dancers, the featured artist, or other performers in the video. Many of these clothing items are items that are generally sold through dispersed markets, such as through boutique shops or independent retailers. Other items may be name brand commodity type items that are easily available at retail locations nation-wide. Of the name brand items, the specific sources for purchasing some of the items will not be easily identifiable in the music video, and the specific sources for purchasing of others of the items will be easily identifiable. The viewer will also see other items used in the video such as furniture, jewelry, cars, boats, etc., some for which the sources for purchasing such items are readily identifiable in the music video, and some for which the specific sources for purchasing the same items are not readily identifiable. The instant invention can be used to market all of the above-listed items, regardless of whether the sources for purchasing the items are readily identifiable; however the instant invention is particularly well-suited for marketing items where the source is not readily identifiable.

Before a music video is aired, information regarding the items displayed in the video that are to be advertised is obtained and stored in a database. This information can include contact information for a seller of an item, such as the seller's name, physical address, web address, email address, phone number, etc. As the music video is playing the items worn and used in the video are advertised by a video overlay, such as a closed captioning overlay, a scrolling marquee, or a caption-bubble overlay, that is displayed on the television screen along with the music video. The video overlay is generally orientated in such a manner so as to minimize any disruption to the music video image, such as at the far bottom or far top of the screen. In one embodiment, the video overlay can be turned on and off at the discretion of the viewer to further minimize disruption of the video. In an alternative embodiment, an audio overlay is utilized instead of a video overlay. To reduce disruption of the entertainment program, the audio overlay is broadcast via a separate audio channel or program (SAP), allowing audio advertisements to be selectively turned on and off by the viewer.

A varying degree of information corresponding to the source of items displayed in an entertainment program can be provided in the program overlay. In one embodiment of the invention, the contact information for the source for purchasing a displayed item (such as seller's name, address, web address, email address or phone number) is presented directly on the overlay. In another embodiment the viewer is presented a pointer to a location, such as a web address to a central web site, in which purchase information for a number of items can be obtained. In this manner multiple items can be listed together for a single video. In addition, items from multiple different entertainment programs can be listed on the single website. In this embodiment, the purchaser will access information in a database to obtain purchase information for the desired item. The items can be listed on the website in a number of ways. When the entertainment program is a music video, items can be listed either by video or song title, by artist, or by any other means suitable for locating a particular item displayed in the music video.

By providing the viewer of an entertainment program information corresponding to a source for purchase of an item displayed in the program, the instant invention provides a new channel for marketing a variety of products not available through prior art marketing systems. Low-volume, or specialty items, such as vintage clothing, specific designs of clothing lines, customized automobiles, jewelry, furniture, etc., which have traditionally been sold through dispersed distribution channels without any marketing, can now be marketed through the instant invention. The instant invention allows items to be marketed at a lower cost than traditional advertising, as the time needed to market an item can be limited to a couple of seconds during the entertainment program, versus more lengthy commercial breaks which usually require enough time to develop a short storyline for advertising the product (usually at least 15 to 30 seconds). In addition, the instant invention more precisely targets products to the specific consumer audience of a segment of the entertainment program. This is particularly beneficial for marketing during music videos, which are often viewed sporadically by viewers of the video network. Certain viewers will watch videos of certain artists, while other viewers will watch videos of others artists. As the fans of a specific artist are the persons most likely to be interested in purchasing clothing worn by, and other items used by, that artist, the instant invention allows marketing efforts to be precisely focused.

The instant invention makes the entire entertainment program a commercial for the items displayed in the program. Marketing takes place during the entire program, as opposed to traditional spaced-apart commercial breaks during a program. Utilizing the instant invention traditional commercial breaks can be eliminated. The ability to market items without the use of commercial breaks can be of great benefit to many entertainment programs, such as dramas, made for television movies, live award shows, etc., in which the disruption caused by commercial breaks is irritating to viewers and can even result in a viewer missing part of the program.

The instant invention allows specific items to be marketed, as opposed to a specific brand of items. The specific design of a shirt worn by a Hip Hop artist in a music video, the specific style of shoes worn by a professional basketball player during a game, the specific sunglasses worn by a baseball player, the night club that is the setting of a music video, the glasses from which a character is drinking during a television sitcom, the furniture used in a scene of a movie, the jewelry worn by a character in a television drama, the dress worn by an actress attending an awards show, as well as any other products or services that can be displayed as part of the entertainment program can be marketed through the use of the instant invention.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is a diagram showing the functional layout of a marketing system of the instant invention in which information corresponding to the source of an item is presented via a program overlay.

FIG. 2 is a diagram showing the functional layout of an alternative embodiment of the marketing system of the instant invention in which information corresponding to the source of an item is listed in a database.

FIG. 3 is a diagram showing a first embodiment of a display overlay of the instant invention.

FIG. 4 is a diagram showing a second embodiment of a display overlay of the instant invention.

### DETAILED DESCRIPTION OF A PREFERRED EMBODIMENT

As required, a detailed embodiment of the present inventions is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

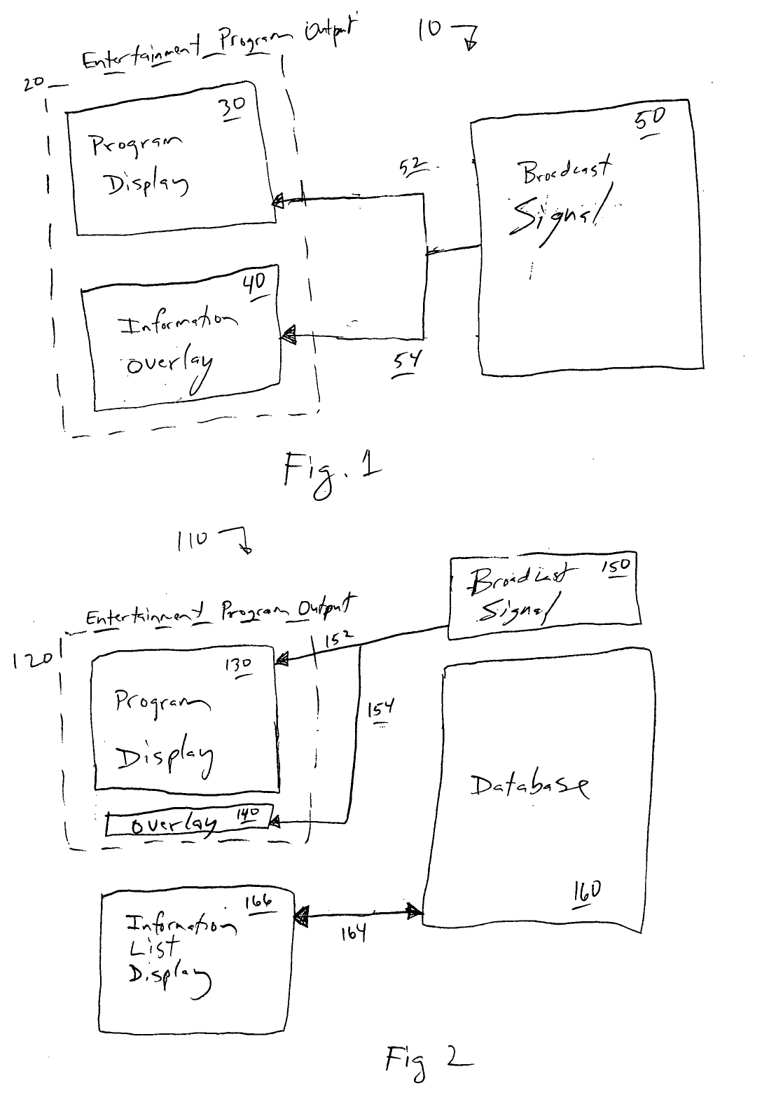

Referring to FIG. 1 a functional layout of an embodiment of a marketing system of the instant invention is presented. Marketing system 10 includes program display 30 and program overlay 40, both of which are components of an entertainment program output, 20, which is broadcast via television signal 50. Broadcast signal 50 can originate from a local television station (such as a local affiliate of ABC, CBS, FOX or NBC) or a cable television station (such as MTV, VH1, TNN, TBS, WGN, USA, ETV or any other cable station), a VCR, a DVD player, a computer media player, or any other equipment suitable for generating a video broadcast signal for an entertainment program. Broadcast signal 50 can be a live broadcast of the entertainment program, or it can be a broadcast of a pre-recorded entertainment program that is stored on media known in the art (i.e. video cassette, DVD, etc.). Entertainment program output 20 is presented to a viewer via a video and audio display device, such as a television. Broadcast signal 50 is transmitted to the display device by means well known in the art, such as coaxial cable, fiber optics, satellite, aerial antenna, etc.

In FIG. 1, broadcast signal 50 is shown as a single signal that contains two components, the entertainment portion of program output 20, and the advertisement portion of program output 20. Component 52 is the portion of the signal that contains the entertainment portion of entertainment program output 20, such as the television show or music video that is being watched for entertainment and which is presented via primary program display 30. In reality component 52 may itself be composed of multiple components such as an audio component and a video component of the entertainment program output. Component 54 is the portion of the signal that contains the advertisement for an item displayed in program display 30. Basically, component 54 acts, at least temporarily, as a storage medium for storing information corresponding to the source for purchase of the item (either the contact information for the seller or a pointer to where the contact information can be obtained) while it is transmitted to program information overlay 40. The advertisement, which generally includes information corresponding to the source for purchase of the item displayed in program display 30, is presented to the viewer of the entertainment program via program information overlay 40.

The depiction of signal 50 in FIG. 1 is merely for purposes of illustrating the components of the instant invention. It will be appreciated that signal 50 may not actually diverge into two physically separate components as shown in FIG. 1. In addition, it is also contemplated that a separate signal could be broadcast for each component. Whether, or how, components 52 and 54 of signal 50 are physically divided from each other, or are broadcast as two individual signals, will depends upon the form of information overlay 40 that is utilized. For example, in a television program, the video component of entertainment portion 52 is presented via the television screen, and the audio component of entertainment portion 52 is presented via the television speakers. Both the audio and video components of entertainment portion 52 of signal 50 make up program display 30. Program overlay 40 can then be presented on a separate screen (such as a picture in picture screen of the television) as a video overlay, or as an audio overlay. In the case of an audio overlay for a television program, component 54 can be included (or divided) and presented as part of the audio component of entertainment portion 52 of signal 50. Alternatively, audio overlay 40 can be separated from the audio component of entertainment portion 52 in the manner of a separate audio program (SAP), to prevent unwanted disruption of the audio portion of the entertainment portion of the entertainment program present in program display 30. In the case of a separate screen, such as picture in picture, presentation of program overlay 40, component 54 may be broadcast as an entirely separate signal or channel from component (entertainment portion) 52.

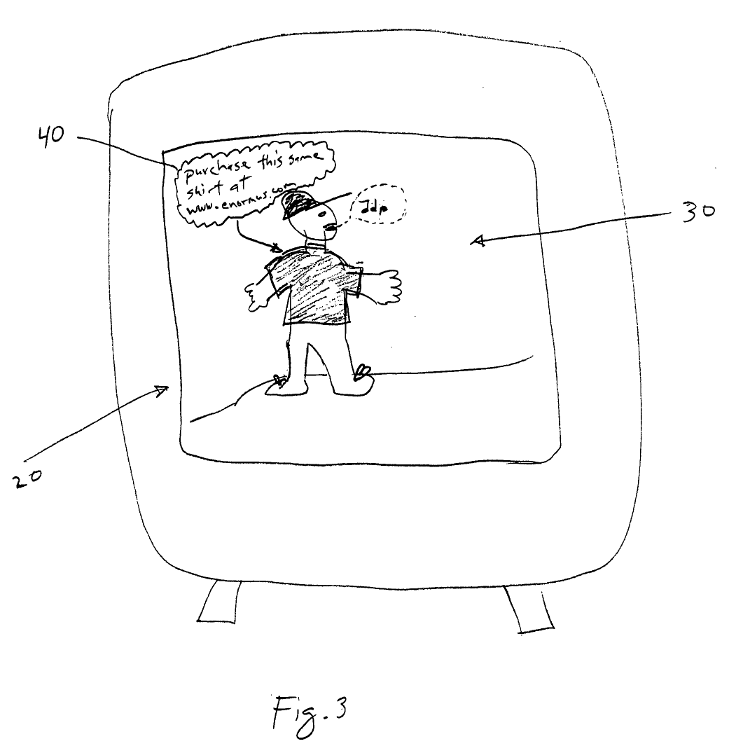

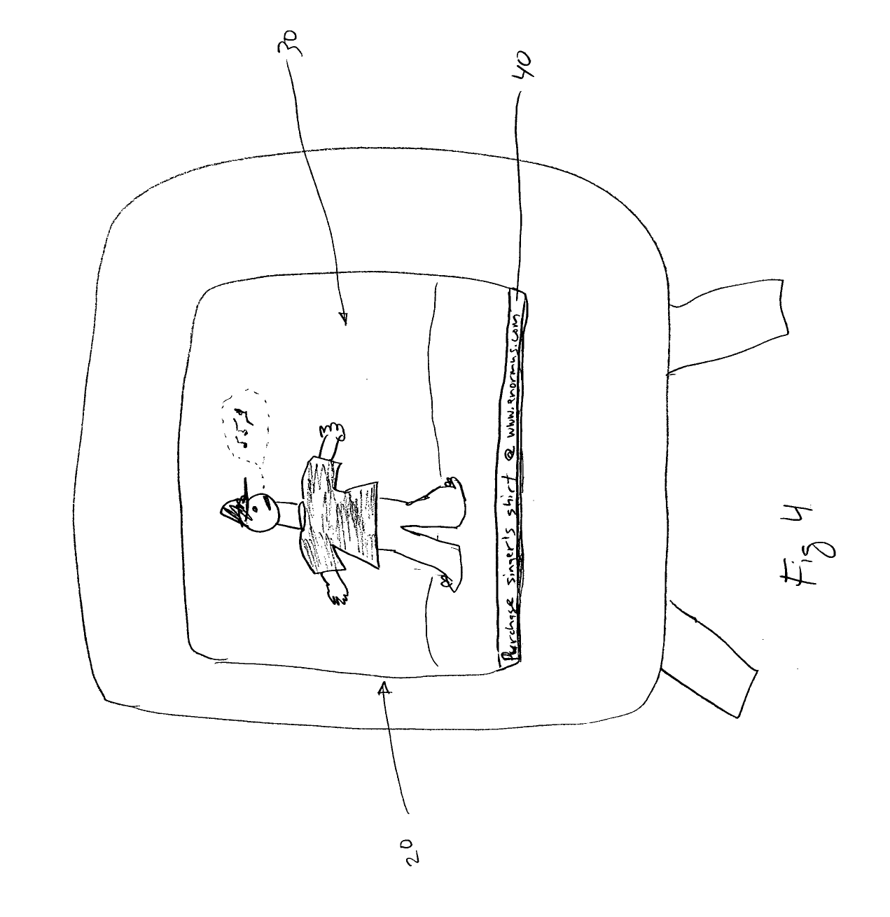

FIGS. 3 and 4, show a preferred embodiment of the instant invention, in which information overlay 40 is a video overlay, similar to either closed captioning or frame overlays currently used by news programs, sports stations, etc., to provide continuous “ticker” updates on the viewer's screen. In FIGS. 3 and 4 video overlay 40 is presented on the same television screen as the entertainment portion of the program (program display 30), basically creating a single entertainment program output that includes both program display 30 and information overlay 40. Components 52 and 54 are broadcast as a single signal. Component 54 is basically a part (or instruction contained in) the video portion of component 54. As with closed captioning, when an entertainment program is broadcast via a television signal, instructions for information overlay 40 are hidden in the line 21 data area found in the vertical blanking interval of signal 50. The vertical blanking area tells the electron gun of the television set which paints the frames of a television program on the television screen to shoot back up to the upper left corner of the screen to begin painting the next frame. Line 21 is the line in the vertical blanking interval that has been assigned to captioning (as well as time and V-chip information). Each frame of video can transmit two characters of captioning information (or special commands that control color, popups, etc.). In FIG. 4, information overlay 40 is located along the bottom of the television screen (program output 20) as a scrolling marquee, below program display 30 to minimize disruption of the entertainment program. In FIG. 3, information overlay 40 is located within program display 30 as a popup or caption-bubble. Using closed captioning technology, overlay 40 shown in FIGS. 3 and 4 can be selectively turned on or off by the viewer of the entertainment program, to further minimize disruption of the entertainment program.

The embodiment of the marketing system shown in FIG. 1 shall now be discussed using a music video as an example. The music video (program display 30) is broadcast via component 52 of signal 50 originating from a television network such as MTV. Prior to broadcasting the video, a list of items to be marketed is obtained along with the source for purchasing those items. As a certain item is displayed, such as the shirt worn by the featured artist in the music video, information overlay 40 is broadcast via component 54 of signal 50. As discussed above, component 54 of signal 50 is instructions for the electron gun of the television set to paint a textual caption on the screen. The textual caption can be contact information for the source for purchasing the same item shown in the video (i.e. seller's physical address, web address, email address, phone number, etc.), or alternatively it can be a pointer (or contact information) for a central location, such as a website, where contact information for purchasing the displayed item is stored. As is shown in FIGS. 3 and 4, program overlay 40 provides a website that can be accessed by the viewer of the video. A viewer desiring to purchase the same item displayed in the music video then uses the seller's contact information to purchase the item.

FIG. 2 shows a functional layout of an embodiment of the marketing system of the instant invention in which information corresponding to the source for purchase of items displayed in an entertainment program is stored in a database, 160. The information corresponding to the source for purchase of the displayed items includes information such as the description or name of the item, and contact information for a seller of the item, such as the seller's physical address, web address, email address, phone number, etc. This information is obtained before the entertainment program is broadcast to the viewer. The information about the items (i.e. the list of items) displayed in the entertainment program is stored in database 160 in association with the entertainment program such that a viewer of the entertainment program can easily locate the list of items displayed in the entertainment program. For example, when the entertainment program is a music video, the list of items can be associated with the song or video title, the artist's name, etc. The viewer of a particular music video can then easily locate the desired item that was seen in the music video by searching in database 160 for the list of items contained under the song or video title or artist's name. The list is displayed via list display 166, which can be a computer monitor, or other display device connected to database 160.

With the addition of database 160 and list display 166, the marketing system shown in FIG. 2 operates and is structured in much the same manner as the system described in FIG. 1. As discussed above with respect to FIG. 1, broadcast signal 150 originates from a source such as a local television station (such as a local affiliate of ABC, CBS, FOX or NBC) or a cable television station (such as MTV, VH1, TNN, TBS, WGN, USA or any other cable station), a VCR, a DVD player, a computer media player, or any other equipment suitable for generating a video broadcast signal for an entertainment program, and can based upon a live broadcast of the entertainment program or a pre-recorded entertainment program. Entertainment program output 120 is presented to a viewer via a video and audio display device, such as a television. Also as discussed above, broadcast signal 150 is shown as a single signal that contains both component 152 transmitting the entertainment portion of program output 120, and component 154 transmitting the advertisement portion of program output 120. Component 152 is the portion of the signal that contains the entertainment portion of entertainment program output 120, such as the television show or music video that is being watched for entertainment and which is presented via primary program display 130. In the embodiment of the marketing system shown in FIG. 2, component 154, which is the portion of the signal that contains the advertisement for an item displayed in program display 30, is optional. If utilized, component 154 generates program overlay 140 which contains a general advertisement or pointer to database 160 where the information for purchasing items can be obtained. In the event program overlay 140 is not utilized for advertising during the entertainment program, it is preferred to provide a traditional advertisement (i.e. a commercial break) before, after or during the entertainment program to provide the viewers the pointer to database 160. In a preferred embodiment the pointer is a web address to a website in which database 160 is located. The viewer will use the web address to access website database 160 via internet connection 164 to obtain the list of items displayed during the entertainment program. The list of items will be displayed on the viewer's computer monitor (display 166).

Although primarily discussed above utilizing closed captioning technology, it will be appreciated that program overlay 40 of the instant invention can be imbedded into signal 50 in any manner currently available in the art or later discovered. For example, program overlay 50 can be an animation that is part of entertainment portion component 52 of signal 50. In one embodiment, program overlay 40 is presented in the form of a scrolling marquee or ticker that is commonly utilized by news programs and sports programs to provide rolling news updates and sports score updates respectively. In such an embodiment, there is no need for special equipment, such as a closed captioning decoder or a television with SAP technology capability. Overlay 40 is incorporated into each frame of the entertainment program displayed through program display 30, preventing the viewer from selectively turning off the overlay as is possible when closed captioning technology is used.

Overlay 40 of the instant invention is presented to the viewer of the entertainment program during the entertainment program, as opposed to traditional commercials which are before or after the entertainment program, or which are presented during breaks in the presentation of the entertainment program. In a preferred embodiment of the invention, program overlay 40 is presented at the same time as, or otherwise at a time generally concurrent with, the display in program display 30 of the item that is being marketed. Presenting overlay 40 at a time generally concurrent with the display of the item being marketed encourages spontaneous purchases by a viewer of the entertainment program, similar to spontaneous purchases made by purchasers of items located in the checkout line of a grocery store. In addition, presentation of overlay 40 at a time generally concurrent with the display of the item being marketed provides direct association between the displayed item and the advertisement, such that the viewer instantly becomes aware that the displayed item is available for purchase. Nevertheless, program overlay 40 can continue throughout the entire entertainment program, both before and after the display of the item being marketed, to allow the viewer ample opportunity to obtain the information necessary for purchasing the displayed item. In addition, as the instant invention will likely be utilized to market multiple items during a single entertainment program, the information for purchasing all items marketed in the entertainment program can be included in a single overlay. For example, in the embodiment in which overlay 40 is a rolling marquee or ticker, a list of all items marketed during the entertainment program and information for purchasing those items can continuously scroll across the bottom of the viewer's television screen.

Although the system and method of the instant invention are particularly suited for marketing items such as clothing that is sold through dispersed markets, and name brand items for which the source for purchasing the item is not easily identifiable in the music video, it will be appreciated that easily identifiable name brand items can also be marketed through the use of the instant invention. In addition, although particularly well-suited for marketing items that are goods (i.e. clothing, jewelry, furniture, etc.), it is understood that service items may also be marketed through the use of the instant invention. For example, a vacation destination that is the setting in a music video, a cruise line that is the setting for a television show, a bar shown in a video, an auto mechanic shop shown in a video, a custom car shop shown or that customized a car shown in a video, etc, can all be marketed through the use of the instant invention.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

1. A method of marketing items comprising the steps of:
displaying during an entertainment program an item;
obtaining information regarding a source for purchase of said item;
generating a program overlay corresponding to said source information; and
presenting during the entertainment program said program overlay.

2. The method as claimed in claim 1 wherein said step of presenting said program overlay is generally concurrent with said step of displaying said item.

3. The method as claimed in claim 1 wherein said program overlay includes said source information.

4. The method as claimed in claim 3 wherein said source information includes a seller's name, a seller's physical address, a seller's web address, a seller's email address or a seller's phone number.

5. The method as claimed in claim 1 wherein said program overlay includes a pointer to said source information.

6. The method as claimed in claim 5 wherein said pointer comprises a web address for a website containing said source information.

7. The method as claimed in claim 6 wherein said website includes a listing of multiple items and source information for each of said items.

8. The method as claimed in claim 1 wherein said program overlay comprises a video overlay.

9. The method as claimed in claim 8 wherein said program overlay comprises a scrolling marquee.

10. The method as claimed in claim 8 where said program overlay comprises a caption.

11. The method as claimed in claim 10 wherein said caption comprises a caption-bubble.

12. The method as claimed in claim 1 wherein said program overlay comprises an audio overlay.

13. The method as claimed in claim 1 wherein said program overlay is separable from said entertainment program display.

14. The method as claimed in claim 1 wherein said entertainment program comprises a music video.

15. The method as claimed in claim 14 where said item comprises a clothing item worn by an entertainer in said music video.

16. A system for marketing items comprising:
a primary display for displaying an entertainment program, the entertainment program including an item;
a storage medium for storing information corresponding to a source for purchase of said item; and
a program overlay generated from said storage medium and presented during the entertainment program.

17. The system as claimed in claim 16 wherein said program overlay is presented generally concurrent with said item in said primary display.

18. The system as claimed in claim 16 wherein the entertainment program comprises a music video.

19. The system as claimed in claim 16 wherein the storage medium comprises a database.

20. The system as claimed in claim 16 wherein the storage medium comprises a television broadcast signal.

21. The system as claimed in claim 16 wherein said program overlay comprises a display overlay.

22. A method of marketing items comprising the steps of:
displaying an item during an entertainment program;
associating information about said item in a list with the entertainment program; and
providing purchasers access to said list.

23. The method as claimed in claim 22 wherein said list is posted on a website.

24. The method as claimed in claim 23 further comprising the step of presenting a web address for said website during the entertainment program and generally concurrent with said step of displaying said item.

25. The method as claimed in claim 22 wherein said associating step comprises listing said information about said item in connection with a title of the entertainment program.

26. The method as claimed in claim 22 wherein said associating step comprises listing said information about said item in connection with a name of an entertainer in the entertainment program.

27. The method as claimed in claim 22 wherein said information about said item comprises a seller's name, a seller's physical address, a seller's web address, a seller's email address, or a seller's phone number.

28. The method as claimed in claim 22 wherein the entertainment program comprises a music video and said associating step comprises listing said information about said item in connection with a title or artist of said music video.

29. A system for marketing items comprising:
a program display for displaying an entertainment program, the entertainment program including an item;
a database for storing information about said item and information relating to the entertainment program; and
an information display for displaying said information about said item in response to a query of said information relating to the entertainment program.

30. The system as claimed in claim 29 wherein said information display comprises a program overlay to said program display.

31. The system as claimed in claim 29 wherein said information display comprises a website.
